(19) United States
(12) Patent Application Publication
(10) Pub. No.: US 2017/0155308 A1
(43) Pub. Date: Jun. 1, 2017

(54) DRIVE DEVICE

(71) Applicant: STABILUS GmbH, Koblenz (DE)

(72) Inventors: MARKUS REIFENHÄUSER, BURGLAHR (DE); KATHRIN KRONZ, MITTELSTRIMMIG (DE); JAN BOCHEN, EITELBORN (DE)

(73) Assignee: STABILUS GmbH

(21) Appl. No.: 15/359,150

(22) Filed: Nov. 22, 2016

(30) Foreign Application Priority Data
Nov. 26, 2015 (DE) 102015120563.7

(51) Int. Cl. H02K 11/215; H02K 7/00

(52) U.S. Cl. CPC H02K 11/215; H02K 7/003

(57) ABSTRACT

A drive device for motor-actuated displacement of a movable component part of a motor vehicle includes: a housing tube in which is arranged a rotary electric motor having a rotor with a radially magnetized permanent magnet; a supporting ring arranged in the housing tube so as to be axially supported at the electric motor; and a sensor arrangement arranged at a determined distance from the electric motor, the sensor arrangement being configured to contactlessly detect rotational movement of the rotor of the electric motor. The sensor arrangement has at least one Hall sensor arranged on a carrier board, the carrier board being supported by the supporting ring so as to be axially supported at the electric motor. The supporting ring is connected to the electric motor by positive engagement and/or frictional engagement.

### BACKGROUND OF THE INVENTION

1. Field of the Invention

The invention is directed to a drive device for motor-actuated displacement of a movable component part of a motor vehicle, with a housing tube in which is arranged a rotary electric motor having a rotor with a radially magnetized permanent magnet, with a sensor arrangement arranged at a determined distance from the electric motor for contactless detection of the rotational movement of the rotor of the electric motor, the sensor having at least one Hall sensor arranged on a carrier board supported by a supporting ring arranged in the housing tube so as to be axially supported at the electric motor.

2. Description of the Related Art

In a drive device of this type, the supporting ring defines the determined distance of the Hall sensor, or Hall sensors, from the permanent magnet of the rotor so that the Hall sensors can optimally detect the magnetic field of the permanent magnet influencing the Hall sensors in a variable manner during the rotational movement of the rotor. For this purpose, the Hall sensors may not be arranged too far from the rotor but also may not be arranged too close to the rotor.

### SUMMARY OF THE INVENTION

It is an object of the invention to provide a drive device of the type indicated above that is constructed in a simple manner and that allows a simple assembly.

According to an aspect of the invention, this object is met in that the supporting ring is connected to the electric motor by positive engagement and/or frictional engagement.

This has the advantage that during the assembly of the electric motor the supporting ring, which is connected to the electric motor by positive engagement and/or frictional engagement, can not only be installed in the housing tube, but is also held at the electric motor. In this way, the supporting ring can be inserted into the housing tube before further component parts which fix the supporting ring, can be held in its reference position and cannot fall out of the housing tube and disrupt the assembly process.

If the supporting ring is connected to the electric motor by a snap-in connection, no special tools are required for fitting the supporting ring to the electric motor. The connection is produced simply by snapping in.

To this end, the supporting ring can have one or more axial retaining arms that extend into corresponding retaining grooves at the end area of the electric motor facing the supporting ring, and the retaining arms have one or more engaging tabs, which engage in corresponding engaging recesses in one or more of the walls of the retaining grooves or contact one or more of the walls of the retaining grooves in a frictionally engaging manner.

Accordingly, no component parts to be assembled separately are required for connecting the supporting ring to the electric motor, which greatly facilitates the assembly of the drive device.

The drive device can serve, for example, to move a door or hatch of a motor vehicle.

If the retaining arm or retaining arms is or are arranged at the radially circumferential lateral surface region of the supporting ring, they cannot impair the magnetic field to be detected by the Hall sensors.

In this way, the retaining arms are constructed so as to spring radially inward to assist in holding the supporting ring at the electric motor.

To ensure the determined distance of the sensor arrangement from the rotor in a simple manner, the supporting ring can have one or more spacers in the region adjacent to the retaining arm, which spacers are directed toward the electric motor, the front sides of the free ends of the spacers abutting the front side of the electric motor facing the supporting ring.

The supporting ring can be loaded against the electric motor by an elastic component part so that the supporting ring is reliably held in its reference position while the drive device is in operation.

For purposes of a simple construction and ease of assembly, the elastic component part can be a ring-shaped or disk-shaped component part made from an elastic material, e.g., rubber, that loads the supporting ring on its side remote of the electric motor and is supported at the housing tube or a structural component part connected to the housing tube.

If the ring-shaped or disk-shaped component part is supported by its side remote of the supporting ring at a closure cap closing the housing tube, the ring-shaped or disk-shaped component part can be a component part that can be installed in a simple manner by inserting into the housing period.

In a preferred manner, a spindle drive having a threaded spindle and a spindle nut is driven in rotation by the electric motor

### BRIEF DESCRIPTION OF THE DRAWINGS

An embodiment example of the invention is shown in the drawings and described more fully in the following. In the drawings:

FIG. 1 is a longitudinal section of an end area of a drive device;

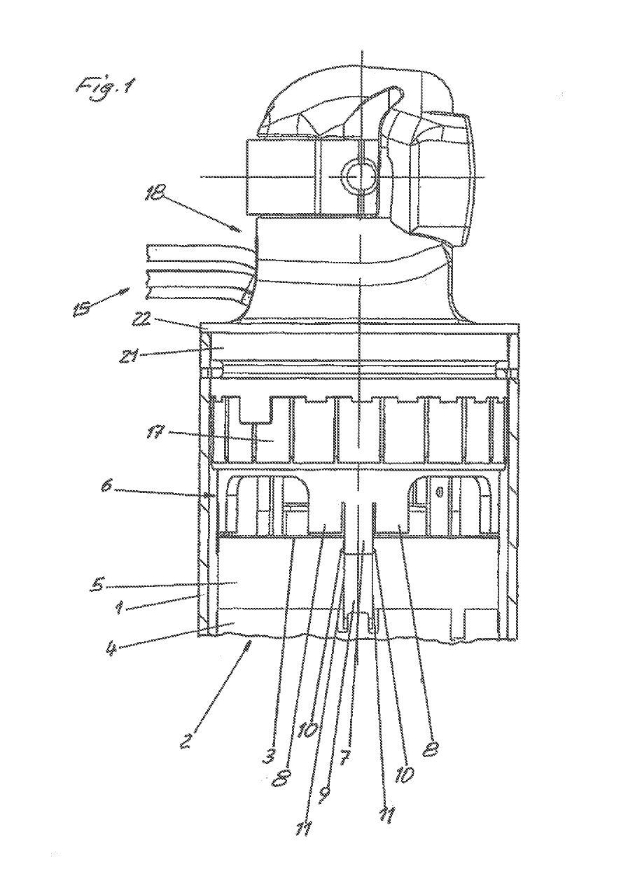

FIG. 2 is a perspective, exploded view of portions of the end area of the drive device according to FIG. 1; and

FIG. 3 is a perspective view of a supporting ring of the drive device according to FIG. 1.

### DETAILED DESCRIPTION OF THE PRESENTLY PREFERRED EMBODIMENTS

The drive device shown in the drawings has a housing tube 1, an electric motor 2 being arranged in an end area of the housing tube 1. A threaded spindle of a spindle drive can be arranged on the side remote of this end area so as to be rotatable by the electric motor 2, e.g., via a gear unit and possibly an overload clutch, and a spindle nut which is fixed with respect to relative rotation but axially displaceable can be arranged on the spindle drive. These component parts which are drivable by the electric motor 2 are not shown.

The electric motor 2 is a rotary electric motor 2 with a rotor, not shown, having a radially magnetized permanent magnet. Facing the end of the housing tube 1, the housing 4 of the electric motor 2 is closed by an end cap 5. The radially magnetized permanent magnet is arranged at a fixed axial distance from the front side 3 of the electric motor 2, which is formed by the front side of the end cap 5.

At the front side of the electric motor 2, a supporting ring 6 is inserted into the housing tube 1. Uniformly distributed around its circumference, the supporting ring 6 has four retaining arms 7 which are directed axial to the electric motor, and a spacer 8 of the supporting ring 6 is arranged adjacent to the retaining arms 7 at both sides in circumferential direction in each instance, the extension of the retaining arms 7 toward the electric motor 2 being greater than the extension of the spacers 8 toward the electric motor.

The supporting ring 6 is inserted into the housing tube until the spacer 8 abuts the front side 3 of the electric motor 2.

The retaining arms 7 extend into axial retaining grooves 9, which are formed at the radially circumferential lateral surface of the end cap 5.

At their free ends facing the electric motor, the retaining arms 7 have engaging tabs 10 which project in radial circumferential direction and which contact the opposite side walls 11 of the retaining grooves 9 in a frictionally engaging manner when retaining arms 7 are inserted into the retaining grooves 9.

As a result of this frictional engagement connection, the supporting ring 6 is held at the electric motor 2 and cannot fall off of the electric motor 2 during continued installation of the drive device.

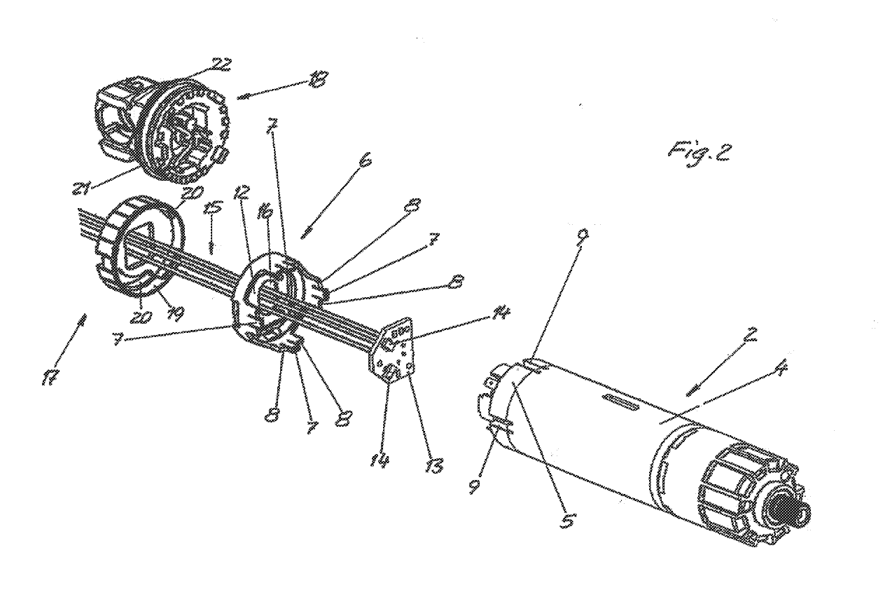

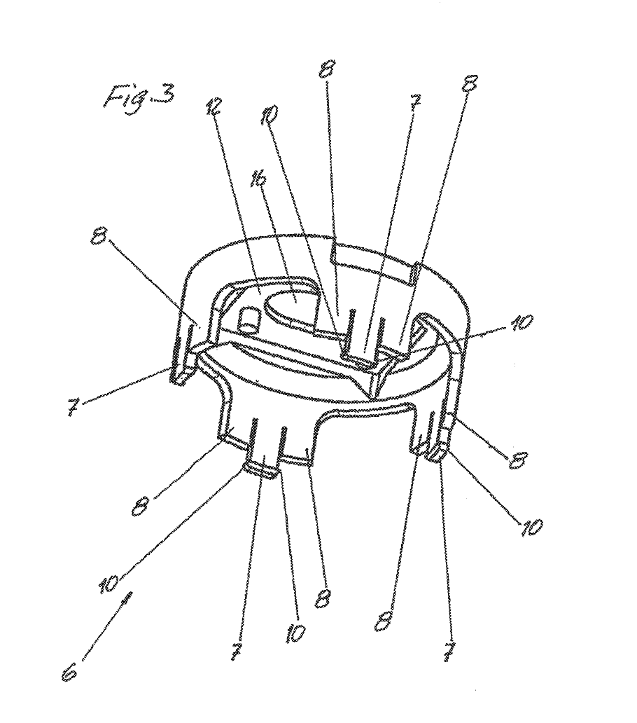

As can be seen, for example, in FIGS. 2 and 3, at the end area of the supporting ring 6 remote of the electric motor 2, the supporting ring 6 has a radially extending carrier plate 12 on which is arranged a carrier board 13, which carries two Hall sensors 14 on its side facing the electric motor 2. These Hall sensors 14 are arranged at a distance from one another in circumferential direction.

Because of the spacers 8 contacting the front side 3 of the electric motor 2, the Hall sensors 14 are at a determined axial distance from the electric motor 2 and, therefore, also from the permanent magnet of the rotor of the electric motor 2.

This determined distance is defined such that the magnetic field of the permanent magnet rotating with the rotor can be detected at least approximately optimally by the Hall sensors 14.

The signals generated by the Hall sensors 14 are guided via lines 15 from the drive device to an evaluating device, not shown, by which information about the number of revolutions and rotational position of the rotor of the electric motor can be derived from these signals. From the latter, the respective position of the spindle drive and/or the displacing speed can be derived in turn.

The lines 15 lead through a recess 16 in the carrier plate 12, through the interior of an annular component part 17 made of rubber and out through a passage in a closure cap 18 closing the housing tube 1.

The annular component part 17 of rubber comprises a sleeve part 19 having an outer diameter equal to the inner diameter of the housing tube 1. In its end area remote of the supporting ring 6, the sleeve part 19 has stops 20 which are directed radially inward. The supporting ring 6, which has an outer diameter corresponding to the inner diameter of the sleeve part 19, is inserted into the sleeve part 19 until contacting the stops 20.

In this way, the annular component part 17, together with the supporting ring 6, causes a decoupling of the vibrations of the electric motor 2 during operation of the drive device and accordingly also a decoupling of noise, which improves the acoustical properties of the drive device.

The annular component part 17, which is made of rubber, contacts the side of the carrier plate 12 of the supporting ring 6 remote of the electric motor 1 via its stops 20 with a slight preloading and is supported by its other side at a cylindrical portion 21 of the closure cap 18. The cylindrical portion 21 of the closure cap 18 has an outer diameter corresponding to an inner diameter of the housing tube 1 and is therefore inserted into the housing tube 1 up to a radially circumferential flange 22 and is fixed in this position by radial beading of the housing tube 1

Thus, while there have been shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended.

### LIST OF REFERENCE NUMERALS

1 housing tube
2 electric motor
3 front side
4 housing
5 end cap
6 supporting ring
7 retaining arms
8 spacer
9 retaining grooves
10 engaging tabs
11 side walls
12 carrier plate
13 carrier board
14 Hall sensors
15 lines
16 recess
17 annular component part
18 closure cap
19 sleeve part
20 stops
21 cylindrical portion
22 flange

What is claimed is:

1. A drive device for motor-actuated displacement of a movable component part of a motor vehicle, the drive device comprising:
a housing tube (1) in which is arranged a rotary electric motor (2) having a rotor with a radially magnetized permanent magnet;
a supporting ring (6) arranged in the housing tube (1) so as to be axially supported at the electric motor (2); and
a sensor arrangement arranged at a determined distance from the electric motor (2), the sensor arrangement being configured to contactlessly detect rotational movement of the rotor of the electric motor (2), the sensor arrangement having at least one Hall sensor (14) arranged on a carrier board (13), the carrier board (13) being supported by the supporting ring (6) so as to be axially supported at the electric motor (2),
wherein the supporting ring (6) is connected to the electric motor (2) by positive engagement and/or frictional engagement.

2. The drive device according to claim 1, wherein the supporting ring (6) is connected to the electric motor (2) by a snap-in connection.

3. The drive device according to claim 1, wherein the supporting ring (6) has one or more axial retaining arms (7) that extend into corresponding retaining grooves (9) at the end area of the electric motor (2) facing the supporting ring (6), wherein each of the retaining arms (7) has one or more engaging tabs (10) configured to engage in corresponding engaging recesses in one or more walls (11) of the retaining grooves (9), or contact one or more of the walls (11) of the retaining grooves (9) in a frictionally engaging manner.

4. The drive device according to claim 3, wherein the one or more axial retaining arms (7) are arranged at a radially circumferential lateral surface region of the supporting ring (6).

5. The drive device according to claim 4, wherein the retaining arms are configured so as to spring radially inward.

6. The drive device according to claim 5, wherein the supporting ring (6) has one or more spacers (8) in a region or regions adjacent to the retaining arm (7), which one or more spacers (8) are directed toward the electric motor (2), wherein front sides of free ends of the spacers (8) abut a front side (3) of the electric motor (2) facing the supporting ring (6).

7. The drive device according to claim 1, wherein the supporting ring (6) is loaded against the electric motor (2) by an elastic component part.

8. The drive device according to claim 7, wherein the elastic component part is a ring-shaped or disk-shaped component part (17) made from an elastic material which loads the supporting ring (6) on a side of the supporting ring remote of the electric motor (2) and is supported at the housing tube or a structural component part connected to the housing tube (1).

9. The drive device according to claim 8, further comprising a closure cap (18) configured to close the housing tube (1), wherein the ring-shaped or disk-shaped component part (17) is supported by a side of the component part (17) remote of the supporting ring (6) at the closure cap (18).

10. The drive device according to claim 1, wherein a spindle drive having a threaded spindle and a spindle nut is driven in rotation by the electric motor (2).
